(19) United States
(12) Patent Application Publication
(10) Pub. No.: US 2022/0142195 A1
(43) Pub. Date: May 12, 2022

(54) METHOD FOR REFRESHING ROASTED COFFEE

(71) Applicant: Bijan B. Yadegar, Los Angeles, CA (US)

(72) Inventor: Bijan B. Yadegar, Los Angeles, CA (US)

(21) Appl. No.: 17/095,579

(22) Filed: Nov. 11, 2020

(51) Int. Cl. A23F 5/10; A23F 5/26; A23F 5/08; A23F 5/46

(52) U.S. Cl. CPC A23F 5/10; A23F 5/46; A23F 5/08; A23F 5/26

(57) ABSTRACT

A method of refreshing roasted coffee, comprising the steps: providing a previously roasted coffee; mixing said previously roasted coffee with water, such that a mixture is created; and heating said mixture in a covered heat safe container via a heating device, such that a refreshed previously roasted coffee is created; and brewing said refreshed previously roasted coffee. The mixture may further comprise one or more flavors and the previously roasted coffee may be instant coffee, ground coffee, and/or whole bean coffee.

### FIELD OF USE

The present disclosure relates generally to devices, systems, and methods that refresh roasted coffee. More specifically, the present disclosure relates to refreshing previously roasted coffee using a heat source.

### BACKGROUND

From the 1800's to 1980s the typical coffee drinking consumer in the United States had access to a handful of mass-produced instant coffee or diner-type robusta batch brewed coffee served in restaurants or for home use. Very few specialty high end coffee bean roasting facilities existed that also featured an exclusive upscale, high priced coffee house setting for freshly roasted, freshly brewed, full bodied, strong flavored and robust arabica coffee drinks. The smell of freshly roasted coffee beans is the signature pleasure of visiting a coffee house that also does coffee roasting.

The whole coffee bean roasting process is a traditional, time-consuming, delicate, and technical process, which requires expensive roasting equipment that is installed within a specifically designed and regulated approved industrial food processing environment that provides for fire safety suppression system, heat exhaust, and ventilation equipment. This equipment is typically operated by specially trained whole coffee bean roasting masters. In sum, roasting green coffee beans to perfection is a delicate, time consuming, and dedicated process that is expensive and requires the use the specialized coffee roasting equipment.

For the past four decades there have been an explosion of European style coffee shops across the United States that has revolutionized the coffee drinking experience. Consumers now have access to both mass-marketed fresh brewed and fresh roasted coffee, single cup pour over coffee, and/or small batch exotic coffees that are strong, proprietary, and uniquely flavored. These specialty coffee shops have been able to capture significant and highly profitable sales away from the traditional coffee serving outlets, such as restaurants, fast food restaurants, convenience stores, and gas stations. Moreover, this trend has caused the entire coffee serving industry to raise the level of quality of coffee being served. Finally, the demand for great coffee is still growing and new products and flavors continue to hit the market. However, consumers are waking up to the fact that many of the specialty coffee shops are very expensive. Thus, there is a significant and growing market demand from traditional coffee serving retailers for better quality, flavor variety, unique, and fresh roasted gourmet coffee drink that have high profit margins, affordable prices, and can be provided via convenient and fast service.

There are several reasons for wanting to re-roast or freshen previously roasted coffee. Some of these reasons include, the desire for a darker roasted beans, the desire for the smell of fresh roasted coffee, or the desire to freshen stale coffee. It is generally accepted that once a coffee has been roasted, re-roasting it will not improve the flavor or freshness of the coffee. Specifically, prior to the method of the present disclosure, attempts to re-roast coffee were unsuccessful because once coffee beans have cooked and cooled, they could not be cooked or roasted further without diminishing or out-right ruining the flavor of the coffee. This is because roasting temperature profiles and sequences make a big difference in how the coffee ultimately tastes. Prior to the method of the present disclosure, re-roasting coffee would result in the coffee oils coming to the surface of the bean and being scorched by the re-roasting process.

Thus, there is a need for a method of using heat to refresh previously roasted coffee that not only does not diminish the taste of the resulting brewed coffee, but instead enhances the flavor and provides the great aroma that is provided by small batch specialty coffee roasting houses. The method of the present disclosure is such a method.

### SUMMARY OF ILLUSTRATIVE EMBODIMENTS

To minimize the limitations in the cited references, and to minimize other limitations that will become apparent upon reading and understanding the illustrative embodiments, the present disclosure teaches a new and useful method for refreshing roasted coffee.

In one embodiment, the method of the present disclosure provides a flash re-roasted coffee that, when used, enhances ordinary coffee to have a rich aroma, freshness, and smooth taste and feel that is associated with coffees made by a professional roast master. The flash re-roasting method allows almost any coffee serving establishment to provide all consumers with easily accessible, price friendly, and consistently great coffee that tastes and smells like it was just roasted and freshly brewed.

In one embodiment, the method and system of the present disclosure provides a just roasted coffee smell, onsite roasted freshness, flavor variety, and enriched quality of freshly roasted and brewed coffee to any coffee serving facility has an oven or source of radiant heat.

The method and system of the present disclosure provides significant advantages because it can be used to enhance the flavor and quality of any type of pre-brewed and post-roasted coffee, including whole coffee beans, ground beans, and instant coffee.

In one embodiment, the method of the present disclosure may comprise the steps: providing pre-roasted coffee; providing water; optionally providing a flavoring; mixing the pre-roasted coffee, water, and (optionally) the flavoring; placing the mixture in a baking type container; covering the container (with a lid, foil, or the like); placing the baking type container in or near a source of heat (oven, conveyor oven, broiler (electric or flame), griddle, or grill); heating the baking container that contains the mixture for 15 seconds to 360 seconds at a temperature of 250 F to 600 F. Preferably, the mixture may be heated for 60 seconds to 180 seconds at 475 F.

Any baking (heat/oven safe) container may be used such a tray, pan, aluminum pan/foil/pouch, sheet, or pot. Preferably the baking container used may be a metal tray or pan that is commonly used in food service kitchens and facilities. However, specialty pans and ceramic dishes may be used so long as they can withstand the heating process. Preferably, the trays used have short lips or sides to prevent the beans from escaping or falling off the tray. Preferably, the side or lip is not more than three inches (3″) deep.

In one embodiment, the roasted coffee may be whole roasted beans that are mixed with water and/or flavoring, heated via the method of the present disclosure, cooled, ground, and brewed. In another embodiment, the roasted coffee may be ground coffee that is mixed with water and/or flavoring, heated via the method of the present disclosure, cooled, and brewed. In another embodiment, the roasted coffee may be instant coffee that is mixed with water and/or flavoring, heated via the method of the present disclosure, cooled, and “brewed”.

Depending on the need, coffee type, coffee brewer size, and equipment, the coffee may preferably be approximately 4.5 ounces of ground, instant, or whole bean coffee to approximately 1.0 to 3.0 ounces of spring or distilled water. Optionally, approximately 0.5 to 2 ounces of a flavoring (preferably a natural flavoring) may be added.

Depending on the need, coffee type, coffee brewer size, and equipment, the heating time may vary. The type of heating device and temperature limitations may also vary the heating time.

By combining the coffee with water (and a flavoring), the step of heating re-activates the natural oil in the coffee without causing a scorched or burnt taste. The heating step also causes the aroma of fresh roasted coffee to fill the restaurant or food service facility, which may have a profound effect on increasing coffee sales.

The steps of removing the refreshed roasted coffee from the baking container and allowing it to cool further spreads the aroma to fill the food service facility in which the method is being practiced. Preferably, the cooling step is approximately 1 second to 120 seconds before brewing, but may be longer.

In one embodiment, the method of the present disclosure may be completed very quickly, wherein the heating time is approximately 100 seconds.

The method of the present disclosure is a way for a traditional coffee serving facility to compete with a specialty coffee house by providing superior coffee and the aroma of freshly roasted coffee beans all at an affordable price with no need to upgrade equipment. The heating step of the method may be used with many of the widely available and currently in use baking devices, ovens, convection ovens, high-speed ovens, programable ovens, combination ovens, and warming ovens.

Furthermore, there is no need for costly specialty labor (roast masters), specialized unique equipment (coffee roasters), or expensive buildouts (exhaust systems, fire safety systems, regulated systems and/or fire suppression systems). The method of the present disclosure may be used with any brand or type (arabica or robusta) of coffee. The method also allows for a convenient and easy way to create a just roasted flavored coffee that is consistent and tastes great.

Although not necessary, facilities that have programmable, high speed, convection, and rotary/conveyor ovens may be able to practice the method of the present disclosure in a very consistent way to ensure perfect refreshed coffee every time. Two examples of well suited ovens to be used with the method of the present disclosure are the Turbochef® Tornado® (which is a type of High Temperature Programable Ventless Impingement Type Convection Oven with Catalytic Converter, hereinafter referred to as a Programmable Convection Oven) and the Turbochef® 1618 (which is a type of High-Speed and High-Temperature Programable Ventless Impingement Type Rotary Belt Convection Oven with Catalytic Converter, hereinafter referred to as a Programable Conveyor Oven).

In addition to traditional radiant heating devices and ovens, microwave ovens may be used. As an example, when heating via a mid-power microwave oven, the coffee and water (and flavoring) are preferably heated for approximately 120 seconds to 240 seconds at 600 W or 1200 W (full power).

Other features and advantages are inherent in the method of refreshing roasted coffee that is claimed and disclosed will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow block diagram showing the steps of the method of refreshing roasted coffee.

### DETAILED DESCRIPTION OF THE DRAWINGS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the present disclosure will become apparent to those skilled in the art from the following detailed description, which shows and describes illustrative embodiments of the present disclosure. As will be realized, the device of the present disclosure is capable of modifications in various obvious aspects, all without departing from the spirit and scope of the present disclosure. Accordingly, the screen shot figures, and the detailed descriptions thereof, are to be regarded as illustrative in nature and not restrictive. Also, the reference or non-reference to a particular embodiment of the present disclosure shall not be interpreted to limit the scope of the present disclosure.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 15% of the indicated number or range of numbers. In one embodiment, the term “approximately” and “about”, refer to a deviance of between 0.0001-40% from the indicated number or range of numbers.

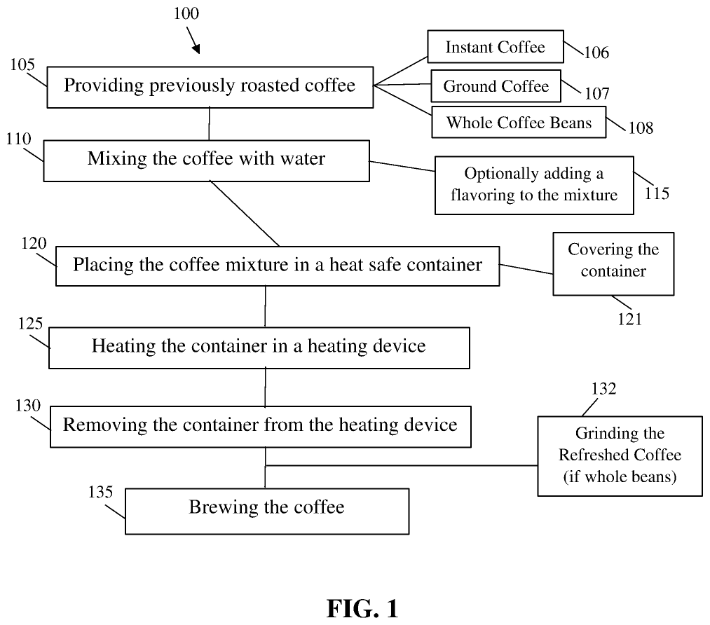

FIG. 1 is a flow block diagram showing the steps of the method of refreshing roasted coffee. FIG. 1 shows that the method 100 of refreshing roasted coffee may comprise the steps: providing previously roasted coffee 105 (which may be instant coffee 106, ground coffee 107, or whole coffee beans 108); mixing the coffee with water 110, and optionally including a flavoring 115; placing the coffee mixture in a heat safe container 120, and preferably covering the container 121; heating the container in heating device (such as an oven) 125; removing the container from the heating device 130; grinding the refreshed coffee (if necessary) 132; brewing the coffee 135. The core steps of the method of the present disclosure are mixing the coffee with water (with an optional adding of a flavoring) and heating the coffee. In various embodiments, the heating device may be any device that is configured to heat food, including, but not limited to: a warming oven, an oven, a convection oven, a toaster oven, a pizza oven, a wood burning oven, a grill (gas or charcoal), a microwave, and/or a broiler (electric or flame). In various embodiments the heat safe container may be any container that can be put in an oven, microwave, grill, or broiler, such as a metal, glass, or ceramic pan, pot, dish, tray, pouch, and/or skillet. The container may be covered with a tight or loose lid or foil, or, if the container is a pouch, sealed by zipper or folding.

The below Table 1 discloses ranges and preferred amounts, times, and temperatures for mixing and heating the coffee mixture.

TABLE 1

| Coffee Mixture | | Oven Type and | Oven Type and |
|---|---|---|---|
| Range | Preferred | Settings-Ranges | Settings-Preferred |
| (instant, ground, | Mixture (all | (all times and | (all times and |
| or whole bean | amounts are | temperatures are | temperatures are |
| coffee) | approximate) | approximate) | approximate) |
| 1.0 to 6.0 | 4.5 ounces of | Programmable | Programmable |
| ounces of coffee | coffee | Conveyor Oven-325° F. | Conveyor Oven- |
| 0.1 to 3.0 | 2.0 ounces of | to 550° F. for 20 to 360 | 475° F. for 100 |
| ounces of water | water | seconds | seconds |
| 0.0 to 2.0 ounce of | 1 ounces of flavor | Programmable | Programmable |
| flavor (optional) | (optional) | Convection Oven- | Convection Oven- |
| | | 325° F. to 500° F. for | 475° F. for |
| | Thus, the preferred | 20 to 360 seconds | 100 seconds |
| | ratio is | Warming- | Warming- |
| | approximately | 100° F. to 175° F. | 150° F. for |
| | 18/8/4 coffee to | for 8 to 12 minutes | 10 mins |
| | water to flavor | Oven- | Oven- |
| | | 300° F. to 500° F. | 475° F. for |
| | | for 30 to 360 seconds | 100 seconds |
| | | Broiler/Pizza- | Broiler/Pizza- |
| | | 350° F. to 800° F. | 450° F. for |
| | | for 10 to 180 seconds | 100 seconds |
| | | Microwave- | Microwave- |
| | | 600 to 1200 Watts | 1200 Watts |
| | | for 10 to 360 seconds | for 100 seconds |

Regarding the flavor that may be added, one or more flavors and/or spices may be used, including, but not limited to extracts, concentrates, and preparations of: Cinnamon; Chicory; Vanilla; Chocolate; Coffee; Mocha Allspice; Almond, Hazelnut, and other nut flavors; Nutmeg; Chai; Amaretto, Rum, and other liquor and liqueur flavors; Anise; Fruit flavors; Chili and other Pepper flavors; Bergamot; Butter; Caramel; Peppermint and other mints; Cloves; Pumpkin spice; Spices; Maple; Cardamom; Coconut; Lime; Lemon; Sweeteners (caloric or calorie free); and/or Honey.

The foregoing description of the specific embodiments will so fully reveal the general nature of the present disclosure that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the present disclosure have been described in terms of preferred embodiments, those skilled in the art will recognize that the embodiments of the present disclosure may be practiced with modification within the spirit and scope of the appended claims.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the embodiments has been presented for the purposes of illustration and description. While multiple embodiments are disclosed, still other embodiments will become apparent to those skilled in the art from the above detailed description. As will be realized, these embodiments are capable of modifications in various obvious aspects, all without departing from the spirit and scope of the protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that these embodiments not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method of refreshing roasted coffee, comprising:
providing a previously roasted coffee;
mixing said previously roasted coffee with water, such that a mixture is created; and
heating said mixture in a heat safe container via a heating device, such that a refreshed previously roasted coffee is created;

2. The method of claim 1, further comprising the step:
brewing said refreshed previously roasted coffee.

3. The method of claim 1, wherein said mixture further comprises one or more flavors.

4. The method of claim 1, wherein said heat safe container that contains said mixture is covered before being heated.

5. The method of claim 1, wherein said previously roasted coffee is an instant coffee.

6. The method of claim 1, wherein said previously roasted coffee is a ground coffee.

7. The method of claim 1, wherein said previously roasted coffee is a whole bean coffee and further comprising the step of grinding said whole bean coffee.

8. The method of claim 1, wherein said heating device is an oven and said mixture is heated to approximately 300 F to 500 F for approximately 30 to 360 seconds.

9. The method of claim 1, wherein said heating device is an oven and said mixture is heated to approximately 475 F for approximately 100 seconds.

10. The method of claim 1, wherein said heating device is a Programmable Convection Oven and said mixture is heated for approximately 90 to 240 seconds.

11. The method of claim 1, wherein said heating device is a Programable Convection Oven and said mixture is heated for approximately 100 seconds.

12. The method of claim 1, wherein said heating device is a Programmable Conveyor Oven and said mixture is heated for approximately 60 to 180 seconds.

13. The method of claim 1, wherein said heating device is a Programable Conveyor Oven and said mixture is heated for approximately 100 seconds.

14. A method of refreshing roasted coffee, comprising:
providing a previously roasted coffee;
mixing said previously roasted coffee with water, such that a mixture is created; and
heating said mixture in a covered heat safe container via a heating device, such that a refreshed previously roasted coffee is created; and
brewing said refreshed previously roasted coffee.

15. The method of claim 14, wherein said mixture further comprises one or more flavors.

16. The method of claim 14, wherein said previously roasted coffee is selected from the group of coffees consisting of one or more of: an instant coffee; a ground coffee; and combinations thereof.

17. The method of claim 14, wherein said previously roasted coffee is a whole bean coffee and further comprising the step of grinding said whole bean coffee.

18. The method of claim 14, wherein heating device is selected from the group consisting of:
a Programable Convection Oven and a Programable Conveyor Oven.

19. A method of refreshing roasted coffee, comprising:
providing a previously roasted coffee;
mixing said previously roasted coffee with water and one or more flavors, such that a mixture is created; and
heating said mixture in a covered heat safe container via a heating device, such that a refreshed previously roasted coffee is created;
brewing said refreshed previously roasted coffee; and
wherein said previously roasted coffee is selected from the group of coffees consisting of one or more of: an instant coffee; a ground coffee; a whole bean coffee; and combinations thereof.

20. The method of claim 19, wherein for every approximately 4.5 ounces of previously roasted coffee in said mixture, approximately 2.0 ounces of water and 1.0 ounces of said one or more flavors are added to said mixture.
